(19) United States
(12) Patent Application Publication
(10) Pub. No.: US 2026/0095088 A1
(43) Pub. Date: Apr. 2, 2026

(54) POWER CONVERSION SWITCHING FREQUENCY CONTROL

(71) Applicant: Raytheon Company, Tewksbury, MA (US)

(72) Inventors: Timothy J. Burgess, Tucson, AZ (US); Peter Richard Olejnik, Tucson, AZ (US)

(21) Appl. No.: 18/904,731

(22) Filed: Oct. 2, 2024

(51) Int. Cl. H02M 1/00

(52) U.S. Cl. CPC H02M 1/0041; H02M 1/0009

(57) ABSTRACT

A power converter includes circuitry configured to provide an output voltage and an output current to a load based on an input voltage and a clock signal. The power converter includes control logic configured to control the clock signal based on at least one operational parameter of a set of operational parameters associated with the power converter and at least one environmental parameter of a set of environmental parameters. The set of operational parameters includes one or more of: the input voltage provided to the power converter; the output current provided by the power converter; and the output voltage provided by the power converter.

### BACKGROUND

The present disclosure relates to switching power converters and, in particular, to operating a switching power converter by a variable clock frequency.

### BRIEF DESCRIPTION

Example embodiments of the present disclosure are directed to a power converter including; circuitry configured to provide an output voltage and an output current to a load based on an input voltage and a clock signal; and control logic configured to control the clock signal based on at least one operational parameter of a set of operational parameters associated with the power converter and at least one environmental parameter of a set of environmental parameters, wherein the set of operational parameters includes one or more of: the input voltage provided to the power converter; the output current provided by the power converter; and the output voltage provided by the power converter.

In any one or combination of the embodiments disclosed herein, the set of operational parameters further includes a phase difference between the output current and the output voltage.

In any one or combination of the embodiments disclosed herein, the control logic is configured to set or modify one or more clock parameters of the clock signal based on the at least one operational parameter and the at least one environmental parameter, wherein the one or more clock parameters include an edge rate of the clock signal.

In any one or combination of the embodiments disclosed herein, the one or more clock parameters further include one or more of: a clock frequency of the clock signal; and a duty cycle of the clock signal.

In any one or combination of the embodiments disclosed herein, the set of operational parameters further includes phase information associated with the input voltage.

In any one or combination of the embodiments disclosed herein, the control logic is configured to: apply a weighting factor to one or more of: the at least one operational parameter; and the at least one environmental parameter; and provide the clock signal based on the weighting factor.

In any one or combination of the embodiments disclosed herein, the set of operational parameters further includes an efficiency value associated with providing the output voltage by the power converter.

In any one or combination of the embodiments disclosed herein, the set of environmental parameters includes a temperature associated with the power converter, a temperature associated with the load, or both.

In any one or combination of the embodiments disclosed herein: the power converter includes a resonant tank circuit including one or more inductors and one or more inverters; and the control logic is configured to set or modify one or more clock parameters of the clock signal such that the resonant tank circuit is configured to resonate at a target operating frequency associated with a target operating condition.

Example embodiments of the present disclosure are directed to a system including: a power converter configured to provide an output voltage and an output current to a load based on an input voltage and a clock signal; control logic configured to provide the clock signal to the power converter based on at least one operational parameter of a set of operational parameters associated with the power converter and at least one environmental parameter of a set of environmental parameters, wherein the set of operational parameters includes one or more of: the input voltage provided to the power converter; the output current provided by the power converter; and the output voltage provided by the power converter.

In any one or combination of the embodiments disclosed herein, the set of operational parameters further includes a phase difference between the output current and the output voltage.

In any one or combination of the embodiments disclosed herein, the control logic is configured to set or modify one or more clock parameters of the clock signal based on the at least one operational parameter and the at least one environmental parameter, wherein the one or more clock parameters include an edge rate of the clock signal.

In any one or combination of the embodiments disclosed herein, the one or more clock parameters further include one or more of: a clock frequency of the clock signal; and a duty cycle of the clock signal.

In any one or combination of the embodiments disclosed herein, the set of operational parameters further includes phase information associated with the input voltage.

In any one or combination of the embodiments disclosed herein, the control logic is configured to: apply a weighting factor to one or more of: the at least one operational parameter; and the at least one environmental parameter; and provide the clock signal based on the weighting factor.

In any one or combination of the embodiments disclosed herein, the set of operational parameters further includes an efficiency value associated with providing the output voltage by the power converter.

In any one or combination of the embodiments disclosed herein, the set of environmental parameters includes a temperature associated with the power converter, a temperature associated with the load, or both.

In any one or combination of the embodiments disclosed herein: the power converter includes a resonant tank circuit including one or more inductors and one or more inverters; and the control logic is configured to set or modify one or more clock parameters of the clock signal such that the resonant tank circuit is configured to resonate at a target operating frequency associated with a target operating condition.

Example embodiments of the present disclosure are directed to a method including: controlling a clock signal based on at least one operational parameter of a set of operational parameters associated with a power converter and at least one environmental parameter of a set of environmental parameters; and providing an output voltage and an output current to a load based on an input voltage and the clock signal, wherein the set of operational parameters includes one or more of: the input voltage provided to the power converter; the output current provided by the power converter; and the output voltage provided by the power converter.

In any one or combination of the embodiments disclosed herein: the set of operational parameters further includes one or more of: a phase difference between the output current and the output voltage; and phase information associated with the input voltage; and controlling the clock signal includes: setting or modifying one or more clock parameters of the clock signal based on the at least one operational parameter and the at least one environmental parameter, wherein the one or more clock parameters include an edge rate of the clock signal; or providing the clock signal based on applying a weighting factor to one or more of the at least one operational parameter and the at least one environmental parameter.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of a system that supports power conversion switching frequency control in accordance with one or more embodiments of the present disclosure.

FIG. 2 illustrates an example flowchart of a method in accordance with one or more embodiments of the present disclosure.

### DETAILED DESCRIPTION

In switching power conversion systems, maintaining the switching clock frequency to be within the designed operation space (e.g., inputs, outputs, environment, and the like) may be crucial for optimizing efficiency and preventing damage to power conversion circuitry.

According to one or more embodiments of the present disclosure, a switching power converter topology is provided that leverages a variable rate switching clock, in which the frequency is controlled based on input voltage, output load, and operational temperature in association with optimizing operational range and efficiency. In some aspects, the power converter topology may use a variable rate clock source, in which the frequency of the variable rate clock source (and accordingly, the switching frequency of the switching power converter) may be dynamically controlled based on operating conditions or environmental conditions in association with optimizing performance over a wide range of operating conditions and environmental conditions. In some aspects, the systems and techniques described herein for controlling the switching frequency of the switching power converter based on operational and environmental conditions may extend the efficiency and operational range of the power converter beyond that of other power converters which have a fixed switching frequency.

A detailed description of one or more embodiments of the disclosed apparatus and method are presented herein by way of exemplification and not limitation with reference to the Figures.

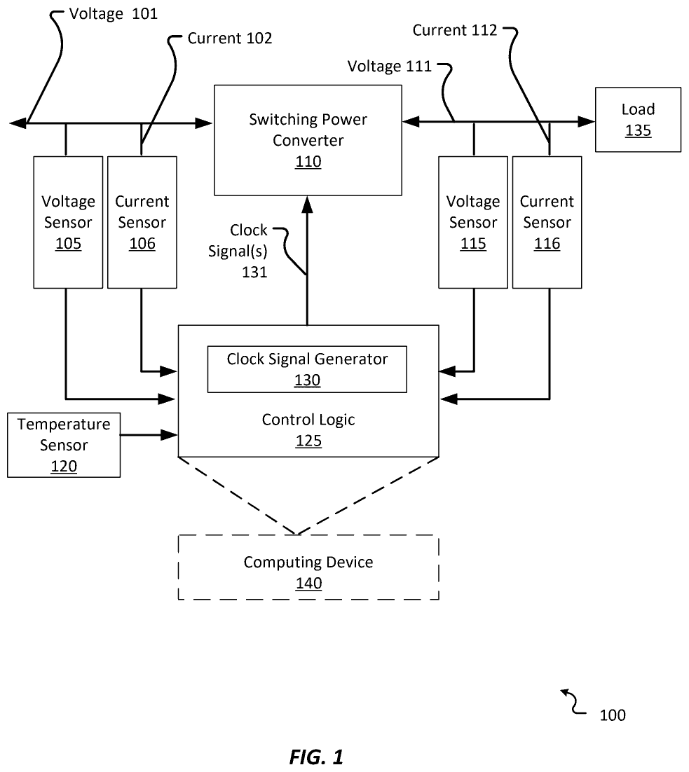

FIG. 1 illustrates an example of a system 100 that supports power conversion switching frequency control in accordance with one or more embodiments of the present disclosure.

The system 100 may include a voltage sensor 105, a current sensor 106, a power converter 110, a voltage sensor 115, a current sensor 116, control logic 125, a temperature sensor 120, and a clock signal generator 130. The system 100 may support driving a load 135.

The voltage sensor 105 may be configured to measure voltage 101 provided to and received by the power converter 110. In some examples, the voltage 101 may be provided by a power source (not illustrated).

The current sensor 106 may be configured to measure current 102 provided to and received by the power converter 110.

The power converter 110 may be a switching power converter capable of generating or producing a switched output power signal (e.g., voltage 111) from power (e.g., voltage 101) input by the power source. The power converter 110 may be a DC/DC converter, a DC/AC converter, an AC/DC converter, or an AC/AC converter. In some embodiments, the AC/AC converter may support providing or converting multi-phase power. For example, the power converter 110 may be a high-performance power converter capable of delivering energy from high-voltage DC sources (e.g., 600 V DC) or high-voltage AC sources (e.g., 240 V AC) to low-voltage DC loads. In some examples, the power converter 110 may provide the voltage 111 in a range of volts to tens of volts, but is not limited thereto.

The power converter 110 may include components (e.g., circuitry) (not illustrated) supportive of functions of the power converter 110. For example, the power converter 110 may include switched inverters (not illustrated), an H-bridge driver, or other suitable components which support the functions of the power converter 110 for receiving DC power from the source and producing a switched AC output power signal. In some examples, the power converter 110 may include a resonant tank circuit (not illustrated) including one or more inductors and one or more capacitors. In some aspects, the resonant frequency of the resonant tank circuit may be controllable based on a clock signal 131 provided to the power converter 110, example aspects of which are later described herein. In some embodiments, the resonant frequency of the resonant tank circuit may be controllable based on multiple respective clock signals 131 (not illustrated) provided to the power converter 110.

It is to be understood that descriptions herein of the clock signal 131 may refer to multiple clock signals 131 (e.g., 1 to n clocks, where n is a positive integer value). For example, embodiments of the present disclosure may include applying multiple clock signals 131 to respectively control functions of the power converter 110. In an example, embodiments of the present disclosure may include applying multiple clock signals 131 to respectively switch different components of the power converter 110.

The voltage sensor 115 may be configured to measure the voltage 111 provided by the power converter 110.

The current sensor 116 may be configured to measure the current 112 provided by the power converter 110.

The voltage sensors (e.g., voltage sensor 105, voltage sensor 115) and current sensors (e.g., current sensor 106, current sensor 116) described herein may include circuitry supportive of functions thereof.

Each of the voltage sensor 105, the current sensor 106, the voltage sensor 115, and the current sensor 116 may be an analog-to-digital converter combined with an amplifier circuit and/or filter circuit, configured to measure voltage or current, but embodiments of the present disclosure are not limited thereto. In some embodiments, the power converter 110 may be implemented using any configuration topology of switching power converter. Non-limiting examples of the power converter 110 include buck converters, boost converters, buck/boost converters, flyback converters, push-pull half bridge or full bridge converters, and the like.

In some embodiments, the control logic 125 and the clock signal generator 130 may reside in an FPGA or an ASIC. Additionally, or alternatively, the control logic 125 and the 130 may be realized with analog circuitry.

The temperature sensor 120 may be, for example, a thermistor (or other suitable thermal sensor) capable of providing temperature measurements to the control logic 125. In some examples, the temperature sensor 120 may be configured to measure temperature at a selected point(s) in or about the system 100 and/or the power converter 110. Non-limiting examples of temperature at the selected points include temperature at a location adjacent to a power switch or temperature at a location adjacent to an isolation transformer of the power converter 110. Other non-limiting examples include the ambient temperature outside the power converter 110. Embodiments of the present disclosure support implementing multiple temperature sensors 120 capable of providing different respective temperature measurements to the control logic 125.

The control logic 125 may include circuitry capable of controlling functions of the power converter 110. In some aspects, the control logic 125 is capable of controlling and providing (e.g., via clock signal generator 130) a clock signal 131 (or multiple clock signals 131) to the power converter 110 in association with controlling operations of the power converter 110.

In some embodiments, the control logic 125 and/or clock signal generator 130 may be included in the power converter 110. In some other examples, the control logic 125 and/or clock signal generator 130 may be implemented as standalone circuitry, a microchip, or other hardware device and be electrically coupled to the power converter 110. For example, the control logic 125 and/or clock signal generator 130 may be implemented in a controller chip. In some embodiments, the control logic 125 may be implemented as a control algorithm executed by a processor of the controller chip.

In some embodiments, the control logic 125 and/or the clock signal generator 130 may be included in a computing device 140, example aspects of which are later described herein. In some other embodiments, the control logic 125 and/or the clock signal generator 130 may be separate from and coupled to the computing device 140.

The clock signal generator 130 may be included in or separate from the control logic 125. The clock signal generator 130 may be configured to generate the clock signal 131 (e.g., a variable frequency clock) based on a control signal provided by control logic 125. The control logic 125 may provide the control signal based on one or more operational parameters, one or more environmental parameters, and/or other criteria described herein.

The load 135 may be, for example, a motor (e.g., an inductive motor), but is not limited thereto. For example, the system 100 may support general power conversion, application specific power conversion, power regeneration, and the like.

According to one or more embodiments of the present disclosure, power may flow in either direction through the power converter 110, for example, as is used in some electric automobile applications. In an example, the system 100 and the power converter 110 may be implemented as a bi-directional power flow architecture that supports bi-directional power flow (e.g., bi-directional power conversion, application specific bi-directional power conversion, bi-directional power regeneration, and the like).

In an example, in a first power conversion direction (e.g., from left to right in FIG. 1), the voltage 101 may be an input voltage, the current 102 may be an input current, the voltage 111 may be an output voltage, and the current 112 may be an output current. In such an example, the voltage 101, current 102, voltage 111, and current 112 may respectively be referred to as a power source voltage, a power source current, a load voltage, and a load current. For example, the voltage 101 and the current 102 may be provided by a power source (not illustrated) to the power converter 110, and the voltage 111 and current 112 may be provided to the load 135 by the power converter 110 based on the conversion techniques described herein.

In another example, in a second power conversion direction (e.g., from right to left in FIG. 1), the voltage 101 may be an output voltage, the current 102 may be an output current, the voltage 111 may be an input voltage, and the current 112 may be an input current. In such an example, the voltage 111 and current 112 may be provided to the power converter 110 from a different power source (not illustrated) or from the load 135, and the power converter 110 may generate and output the voltage 101 and the current 102 based on the power conversion techniques described herein. In such an example, the voltage sensor 115 may be configured to measure the voltage 111 provided to and received by the power converter 110, and the current sensor 116 may be configured to measure the current 112 provided to and received by the power converter 110.

The computing device 140 may be disposed in operable communication with components (e.g., voltage sensor 105, power converter 110, voltage sensor 115, current sensor 116, temperature sensor 120, and the like) of the system 100. The system 100 supports communication between the computing device 140 and other components or devices of the system 100 via wired communication protocols, wireless communication protocols (e.g., electromagnetic (EM) signals, WiFi, Bluetooth™, ZigBee™, Ubiquiti™, 3G, 4G, LTE, and the like), and/or combinations including one or more of the foregoing.

The computing device 140 is configured to receive, store and/or transmit data generated from components and devices of the system 100. The computing device 140 includes processing components configured to analyze received data. The computing device 140 includes processing components configured to provide data and/or control signals to other components of the system 100. The computing device 140 includes any number of suitable components, such as processors, memory, communication devices and power sources. The computing device 140 may include processing circuitry capable of executing instructions stored on a memory of the computing device 140 in association with performing one or more functions described herein. The control logic 125 may include processing circuitry capable of executing instructions stored on a memory of the control logic 125 in association with performing one or more functions described herein. For example, in some embodiments, the control logic 125 may be implemented in a field programmable gate array (FPGA), an application specific integrated circuit (ASIC) device, or the like.

In various embodiments, the system 100 may include user interface components such as, for example, a display screen, speaker, microphone, wearable devices, keyboard, mouse, printer, touchpad, game controllers, and haptic devices. The computing device 140 and system 100 may provide data to a user or receive inputs from the user via the user interface components.

In accordance with one or more embodiments of the present disclosure, the power converter 110 may be configured to provide the voltage 111 and the current 112 to the load 135 based on the voltage 101 (e.g., an input voltage) and the clock signal 131.

In some aspects, the control logic 125 may be configured to provide the clock signal 131 to the power converter 110 based on a set of operational parameters associated with the power converter 110 and/or a set of environmental parameters. In some aspects, the control logic 125 may be configured to provide the clock signal 131 to the power converter 110 based on one or more of the operational parameters associated with the power converter 110 and/or one or more of the environmental parameters.

For example, the control logic 125 may be configured to set or modify one or more clock parameters of the clock signal 131 based on the set of operational parameters and/or the set of environmental parameters. The one or more clock parameters may include an edge rate of the clock signal 131, a clock frequency of the clock signal 131, and a duty cycle of the clock signal 131.

The set of operational parameters may include, for example, the voltage 101 provided to the power converter 110, the current 112 provided by the power converter 110, and the voltage 111 provided by the power converter 110.

In some examples, the set of operational parameters may include a phase difference between the current 112 and the voltage 111. For example, in some aspects, the control logic 125 may use the phase difference as an input to control the power conversion process described herein.

In some examples, the set of operational parameters may include phase information associated with the voltage 101. For example, in some aspects, the control logic 125 may use the phase information as an input to control the power conversion process described herein. In an example, the control logic 125 may use a phase difference between the current 102 and the voltage 101 as an input to control the power conversion process described herein.

In some examples, the set of operational parameters may include an efficiency value associated with providing the output voltage by the power converter 110.

The set of environmental parameters may include an operational temperature associated with the power converter 110, a temperature associated with the load 135, or both. The temperature sensor 120 (or multiple temperature sensors 120) may be configured to measure the temperature associated with the power converter 110 (e.g., at a power switch, an isolation transformer, ambient temperature outside the power converter 110, and the like), the temperature associated with the load 135, or both.

In some aspects, the control logic 125 may be configured to apply a weighting factor to any of the operational parameters and/or any of the environmental parameters. In an example, the control logic 125 may be configured to provide the clock signal 131 based on applying the weighting factor(s) to the operational parameter(s) and/or environmental parameter(s). Accordingly, for example, embodiments of the present disclosure support implementations in which any of the operational parameters or environmental parameters may have a relatively higher or lower impact on setting or modifying the clock signal 131. In some embodiments, the computing device 140 may implement one or more algorithms for weighting any of the operational parameters and/or any of the environmental parameters in association with achieving improved performance associated with power conversion described herein.

In some aspects, the power converter 110 may include a resonant tank circuit (not illustrated) including one or more inductors and one or more capacitors. In some embodiments, the control logic 125 may be configured to set or modify one or more clock parameters of the clock signal 131 such that the resonant tank circuit resonates at a target operating frequency associated with a target operating condition (e.g., associated with driving or powering the load 135, a mode of operation of the power converter 110).

Accordingly, for example, the control logic 125 may be configured to set a clock parameter (e.g., edge rate, clock frequency, duty cycle, or the like) of the clock signal 131 based on an operational parameter (e.g., voltage 101, current 102, current 112, voltage 111, phase information associated with the voltage 111, phase difference between the current 112 and the voltage 111, phase information associated with the voltage 101, phase difference between the current 102 and the voltage 101), an environmental parameter (e.g., temperature, or the like), or other parameter (e.g., the a target resonant frequency for the resonant tank circuit) described herein.

In accordance with one or more embodiments of the present disclosure, the system 100 is a power conversion system capable of improved performance and improved frequency control compared to other approaches. For example, in some other approaches, a switching power converter operates from a fixed rate clock source. The techniques described herein for controlling the frequency of the clock signal 131 (and accordingly, switching operation within the power converter 110) support effective control of dead switching time associated with some switching power converters.

Embodiments of the present disclosure are not limited to the examples described herein. For example, in some embodiments, the control logic 125 and/or the clock signal generator 130 may be included in the power converter 110. In some other embodiments, the control logic 125 and/or the clock signal generator 130 may be separate from and coupled to the power converter 110.

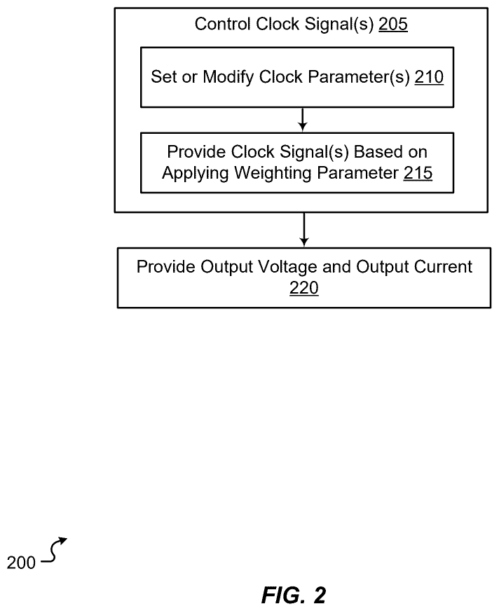

FIG. 2 illustrates an example flowchart of a method 200 in accordance with one or more embodiments of the present disclosure. The method 200 may be implemented by the example aspects of components (e.g., system 100, power converter 110, control logic 125) described herein.

At 205, the method 200 includes controlling a clock signal (or clock signals) based on at least one operational parameter of a set of operational parameters associated with a power converter and at least one environmental parameter of a set of environmental parameters.

In some aspects, controlling the clock signal may include (at 210) setting or modifying one or more clock parameters of the clock signal based on the at least one operational parameter and the at least one environmental parameter, where the one or more clock parameters include an edge rate of the clock signal.

In some aspects, controlling the clock signal may include (at 215) providing the clock signal based on applying a weighting factor to one or more of the at least one operational parameter and the at least one environmental parameter.

In some examples, the set of operational parameters may include one or more of: the input voltage provided to the power converter; the output current provided by the power converter; and the output voltage provided by the power converter.

In some examples, the set of operational parameters further includes one or more of: a phase difference between the output current and the output voltage; and phase information associated with the input voltage.

At 220, the method 200 may include providing an output voltage and an output current to a load based on an input voltage and the clock signal (or clock signals). In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

It is to be understood that descriptions of controlling the clock signal in association with the method 200 may include controlling multiple clock signals in association with providing an output voltage and an output current by a power converter as described herein.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the various embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A power converter comprising;
circuitry configured to provide an output voltage and an output current to a load based on an input voltage and a clock signal; and
control logic configured to control the clock signal based on at least one operational parameter of a set of operational parameters associated with the power converter and at least one environmental parameter of a set of environmental parameters,
wherein the set of operational parameters comprises one or more of:
the input voltage provided to the power converter;
the output current provided by the power converter; and
the output voltage provided by the power converter.

2. The power converter of claim 1, wherein the set of operational parameters further comprises a phase difference between the output current and the output voltage.

3. The power converter of claim 1, wherein the control logic is configured to set or modify one or more clock parameters of the clock signal based on the at least one operational parameter and the at least one environmental parameter,
wherein the one or more clock parameters comprise an edge rate of the clock signal.

4. The power converter of claim 3, wherein the one or more clock parameters further comprise one or more of:
a clock frequency of the clock signal; and
a duty cycle of the clock signal.

5. The power converter of claim 1, wherein the set of operational parameters further comprises phase information associated with the input voltage.

6. The power converter of claim 1, wherein the control logic is configured to:
apply a weighting factor to one or more of:
the at least one operational parameter; and
the at least one environmental parameter; and
provide the clock signal based on the weighting factor.

7. The power converter of claim 1, wherein the set of operational parameters further comprises an efficiency value associated with providing the output voltage by the power converter.

8. The power converter of claim 1, wherein the set of environmental parameters comprises a temperature associated with the power converter, a temperature associated with the load, or both.

9. The power converter of claim 1, wherein:
the power converter comprises a resonant tank circuit comprising one or more inductors and one or more inverters; and
the control logic is configured to set or modify one or more clock parameters of the clock signal such that the resonant tank circuit is configured to resonate at a target operating frequency associated with a target operating condition.

10. A system comprising:
a power converter configured to provide an output voltage and an output current to a load based on an input voltage and a clock signal;
control logic configured to provide the clock signal to the power converter based on at least one operational parameter of a set of operational parameters associated with the power converter and at least one environmental parameter of a set of environmental parameters,
wherein the set of operational parameters comprises one or more of:
the input voltage provided to the power converter;
the output current provided by the power converter; and
the output voltage provided by the power converter.

11. The system of claim 10, wherein the set of operational parameters further comprises a phase difference between the output current and the output voltage.

12. The system of claim 10, wherein the control logic is configured to set or modify one or more clock parameters of the clock signal based on the at least one operational parameter and the at least one environmental parameter,
wherein the one or more clock parameters comprise an edge rate of the clock signal.

13. The system of claim 12, wherein the one or more clock parameters further comprise one or more of:
a clock frequency of the clock signal; and
a duty cycle of the clock signal.

14. The system of claim 10, wherein the set of operational parameters further comprises phase information associated with the input voltage.

15. The system of claim 10, wherein the control logic is configured to:
apply a weighting factor to one or more of:
the at least one operational parameter; and
the at least one environmental parameter; and
provide the clock signal based on the weighting factor.

16. The system of claim 10, wherein the set of operational parameters further comprises an efficiency value associated with providing the output voltage by the power converter.

17. The system of claim 10, wherein the set of environmental parameters comprises a temperature associated with the power converter, a temperature associated with the load, or both.

18. The system of claim 10, wherein:
the power converter comprises a resonant tank circuit comprising one or more inductors and one or more inverters; and
the control logic is configured to set or modify one or more clock parameters of the clock signal such that the resonant tank circuit is configured to resonate at a target operating frequency associated with a target operating condition.

19. A method comprising:
controlling a clock signal based on at least one operational parameter of a set of operational parameters associated with a power converter and at least one environmental parameter of a set of environmental parameters; and
providing an output voltage and an output current to a load based on an input voltage and the clock signal,
wherein the set of operational parameters comprises one or more of:
the input voltage provided to the power converter;
the output current provided by the power converter; and
the output voltage provided by the power converter.

20. The method of claim 19, wherein:
the set of operational parameters further comprises one or more of:
a phase difference between the output current and the output voltage; and
phase information associated with the input voltage; and
controlling the clock signal comprises:
setting or modifying one or more clock parameters of the clock signal based on the at least one operational parameter and the at least one environmental parameter, wherein the one or more clock parameters comprise an edge rate of the clock signal; or
providing the clock signal based on applying a weighting factor to one or more of the at least one operational parameter and the at least one environmental parameter.
